(19) United States
(12) Patent Application Publication
(10) Pub. No.: US 2026/0099829 A1
(43) Pub. Date: Apr. 9, 2026

(54) SYSTEMS AND METHODS FOR PAYMENT ROUTING

(71) Applicant: Sila Inc., Dover, DE (US)

(72) Inventors: Derek John Zumsteg, Dover, DE (US); Shamir Karkal, Dover, DE (US)

(21) Appl. No.: 19/350,860

(22) Filed: Oct. 6, 2025

Related U.S. Application Data
(60) Provisional application No. 63/703,381, filed on Oct. 4, 2024.

(51) Int. Cl. G06Q 20/10; G06Q 20/36; G06Q 20/40

(52) U.S. Cl. CPC G06Q 20/108; G06Q 20/36; G06Q 20/407

(57) ABSTRACT

A computer-implemented method for optimized payment routing includes receiving API messages from a plurality of enrolled users, where each API message contains a transaction request for transferring funds. The transaction request includes transaction information specifying a value of funds to be transferred, a source identifier, and a destination identifier. The method processes the API messages by accessing a collection of enrolled payment routes, where each payment route comprises a different combination of payment rails and payment providers for transferring funds. At least one payment rail is combined with different respective payment providers to create multiple routing options. The method selects an optimized payment route from the plurality of available payment routes based on the specific transaction requirements and submits a routing request to execute the transaction using the selected payment route in accordance with the transaction information. This approach enables dynamic optimization of payment routing by providing access to multiple payment networks and providers through a single interface.

### CROSS REFERENCE TO RELATED APPLICATIONS

This application claims the benefit of and priority to U.S. Provisional Application No. 63/703,381 filed on Oct. 4, 2024. The entire contents of these applications are incorporated herein by reference herein in their entirety.

### FIELD

The disclosed embodiments generally relate to the field of distributed computer systems, routing, networks, application programming interfaces, and payment systems, and more particularly to optimized routing of transactions using digital payment systems.

### BACKGROUND

Automated Clearing House (ACH) is an electronic funds transfer system that facilitates payments and uses a computer-based electronic network for processing transactions. ACH is the main U.S. bank to bank payments system and can move over $80 trillion annually. In its standard mode, ACH is a batch file-based system that generally operates overnight on business days. ACH supports both push (meaning credit) and pull (meaning debit) payments. Same Day ACH is a capability that was added to ACH in 2016 that allows payments sent in the morning or early afternoon to be processed and forwarded to the receiving bank on the same day.

A real time payment system referred to as RTP was launched by The Clearing House® in 2017. RTP is a push-only payment system that operates twenty-four hours a day, seven days a week, each day of the year. Another real time payment system referred to as FedNOW® was launched by the Federal Reserve in 2023. FedNOW is a push-only payment system that operates twenty-four hours a day, seven days a week, each day of the year.

Request for Payment (RFP) is a digital message type for both RTP and FedNOW that allows a user to digitally request a payment from another account or user. If the recipient approves the request within a stipulated expiry time, then their bank will make a push payment to the originator of the message. This effectively replaces pull payments with real-time authorized push payments.

Currently, the financial institutions that make financial transactions have limited choice about which payment route to use (RTP, FedNow, SWIFT, etc.) in accordance with specific limited requirements of the transaction.

Embodiments described herein relate to improved systems and methods for faster, more reliable, and more efficient electronic-payments routing.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, disclosed is a computer-implemented method for optimized payment routing. In some aspects, the methods include receiving API messages for a plurality of enrolled users, where each API message has a transaction request from one of the users requesting a transfer of funds. The transaction request may include transaction information that includes a value of the funds requested to be transferred, a source identifier, and a destination identifier.

The methods may further include processing one of the API messages by accessing the transaction information in the transaction request. This processing may include accessing a collection of a plurality of enrolled payment routes, where each payment route includes a different combination of a plurality of payment rails and a plurality of payment providers for transferring funds. In some cases, at least one of the payment rails of the plurality of payment rails may be combined with different respective payment providers of the plurality of payment providers.

The methods may include selecting a payment route from the plurality of payment routes to use for the requested transfer and submitting a routing request for routing the transaction request using the selected payment route and in accordance with the transaction information.

In some embodiments, the methods may further include monitoring in real-time or near real-time the routing of the transaction via the selected payment route for a failure, deciding whether to intervene in the routing of the transaction due to the failure, and upon deciding to intervene, repeating the selecting of the payment route for selecting a revised payment route from the plurality of payment routes included in the enrolled payment routes. The methods may also include submitting a failover routing request for routing the transaction using the revised payment route.

In one or more embodiments, the methods may include identifying a plurality of payment routes in the collection that are compatible for transferring the funds per the user transaction request and creating bid callouts for only the respective compatible payment routes, where selecting the payment route includes evaluating the bid callouts.

The evaluation of bid callouts may include accessing historical data from past transactions routed via the different enrolled payment routes and predicting cost and/or speed of routing the transaction. The predicting may use historical data of the historical past transactions that is relevant to the destination identifier for the transaction and optimization routing rules, where selecting the payment route may be based on a result of the predicted cost and/or speed.

In some embodiments, the historical data for a particular payment route may include failure data about returns or failures that occurred when using the payment route for past transactions, speed of routing respective past transactions using the payment route, and cost incurred for using the payment route for routing the past transactions.

In one or more embodiments, the methods may further include applying a machine learning model to analyze the historical data for predicting the cost and/or speed. In some embodiments, the methods may include receiving external bids associated with usage of respective payment routes of the plurality of payment routes, where evaluating the bid callouts includes determining effects of the received external bids on routing the transaction for the respective compatible payment routes, and where selecting the payment route may be based on the determined effects.

In one or more embodiments, the methods may include accessing contract data representing contract terms of a contract between the payment route and the user and/or contract terms of a contract between the different enrolled payment routes and the routing selection system, where evaluating the bid callouts may be based on an evaluation of application of the contract terms to the plurality of payment routes and/or selecting the payment route may be based on an evaluation of application of the contract terms to the compatible payment routes.

The transaction request may include an optimization selection, where the optimization selection specifies a characteristic to use for optimizing the routing of the transaction request. The characteristic may be selectable from cost for routing the transaction and speed of routing the transaction, and selecting the payment route may be further optimized on the optimization selection.

In some embodiments, the methods may include generating the routing request based on the user transaction request and the selected payment route. The methods may further include applying a machine learning model to determine additional data to insert in the routing request, where generating the routing request includes inserting the additional data.

The transaction request may request a plurality of transactions. In some cases, each of the users may have access to a digital wallet executing on an associated user device, where the API messages are received from the digital wallets of the associated user devices of the respective users.

In accordance with another aspect of the disclosure, systems are also disclosed that include at least one memory storing programmable instructions and at least one processor in communication with the at least one memory, where the at least one processor, upon execution of the programmable instructions, may be caused to perform the methods described herein.

In accordance with another aspect of the disclosure, computer-readable media are also disclosed that store programmable instructions that, when executed by at least one processor, cause the at least one processor to perform the methods described herein. The computer-readable media may include non-transitory storage media such as memory devices, optical discs, magnetic storage devices, or other suitable storage mechanisms for maintaining the programmable instructions in a retrievable format.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIGS. 1A-1C are diagrams of a system for payment routing according to embodiments described herein.

FIG. 2 is a diagram of a system for translating transaction requests according to embodiments described herein.

FIG. 3A is a diagram of a process for payment routing according to embodiments described herein.

FIG. 3B is a diagram of a process for payment routing according to additional embodiments described herein.

FIG. 4 shows an example schematic diagram of a distributed computer system for payment routing according to some embodiments.

FIG. 5 shows an example schematic diagram of a distributed computer system with capabilities of using a neural network for payment routing according to some embodiments.

Identical reference numerals have been used, where possible, to designate identical elements that are common to the figures. However, elements disclosed in one embodiment may be beneficially utilized on other embodiments without specific recitation.

### DETAILED DESCRIPTION

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a memory storage device or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

Embodiments described herein relate to methods, systems, devices, and computer-readable media for digital payment routing. Embodiments described herein relate to methods, systems, devices, and computer-readable media for digital payment routing that includes selection of which combination of payment rails and payment providers to use. Payment rails are systems that facilitate the transfer of funds between parties, such as financial institutions, businesses, and individuals.

Embodiments described herein relate to improved systems and methods for digital payments that involving receiving a transaction request having a destination identifier (e.g. routing+account number) and a source identifier (e.g. routing+account number) and routing the transaction as requested using the appropriate payment route. The payment route includes a selected payment rail (e.g., ACH, RTP, or FedNOW, Wire transfers, SWIFT) and a selected provider (e.g., The Clearing House, Federal Reserve, NACHA)), Selections can be optimized based on criteria, e.g., speed and/or cost. The payment route for the transaction can be selected based on historical data and optimization routing rules.

For example, a transaction request can be provided by a payment application executing on a user device associated with a user, such as a digital wallet. The payment application can call an API executing on a transaction server. The user can use a user interface (e.g., a GUI) provided by the payment application to enter details about a desired transaction. The payment application uses the information provided by the user to generate an API message with corresponding transaction information (e.g., source and destination identifiers and transaction amount, as well as any other transaction parameters, such as payment time). The user can also specify an optimization parameter to use for optimizing the transaction. Examples of optimization parameters include speed and cost. The transaction server processes the transaction request by selecting an optimized payment route and routes the transaction request to the selected payment route.

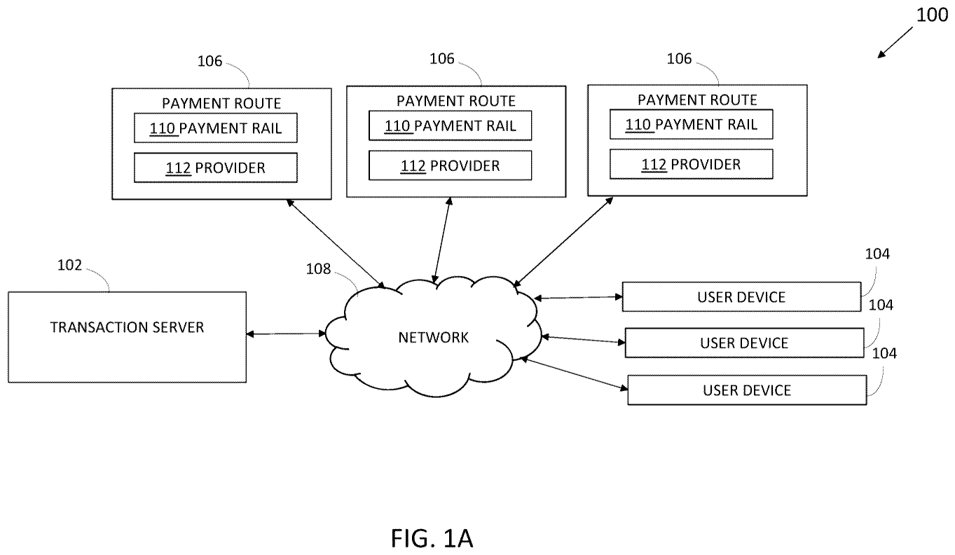

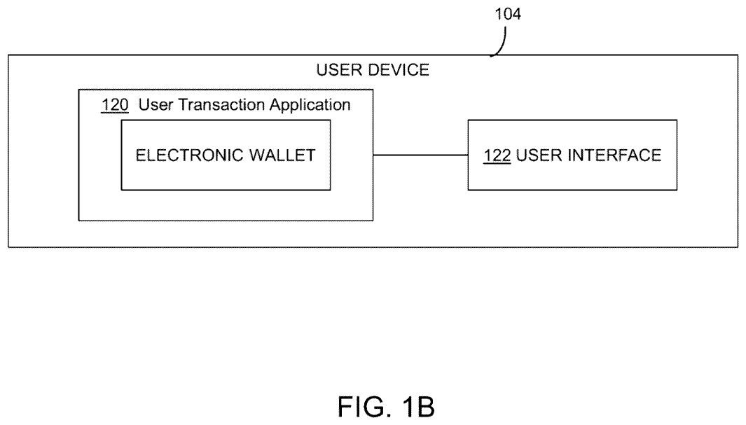

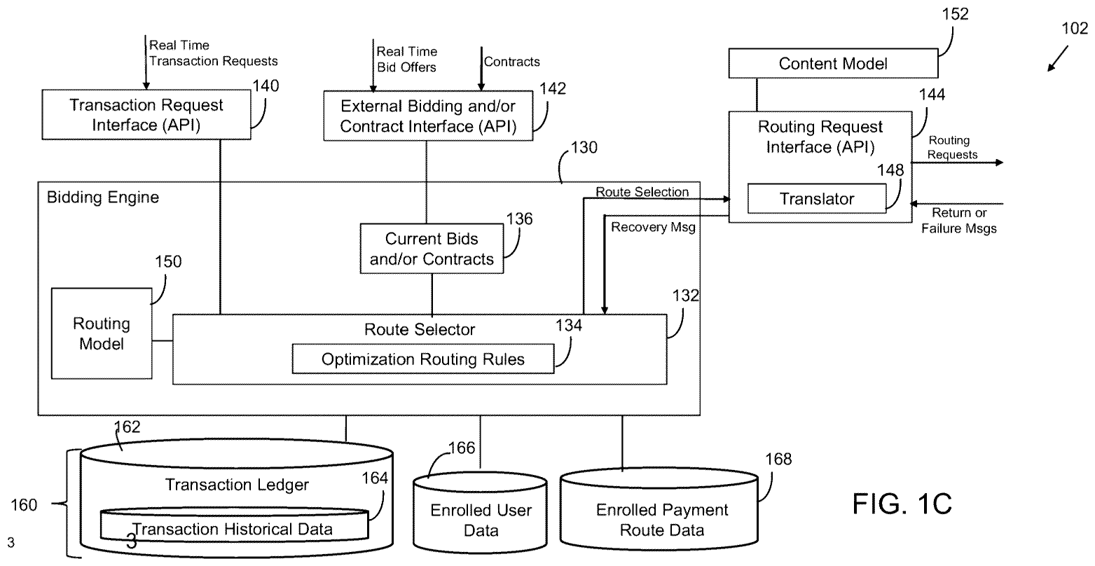

With reference to FIG. 1A, digital payment system 100 includes a transaction server 102, a plurality of user devices 104, a plurality of payment routes 106, and a network 108. The drawings are not meant to limit the number of user devices 104, payment routes 106, or other elements of digital payment system 100. Transaction server 102 communicates with user devices 104 and with payment routes 106 via network 108.

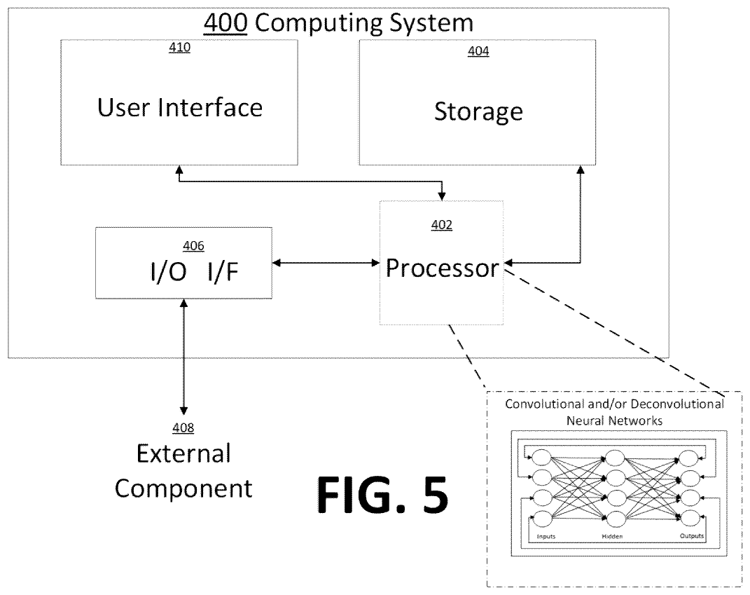

Each of transaction server 102, user devices 104, and payment routes 106 include one or more computers. The respective computers include one or more processors coupled with one or more memories. The one or more memories store programmable instructions. The one or more processors, upon execution of the programmable instructions are caused to perform the corresponding disclosed methods. The one or more computers can be configured as shown and described with respect to FIG. 5.

Network 108 can include one or more networks, which can include one or more of different types of networks, alone or in a combination, such as a proprietary, enterprise network, a virtual private network (VPN), a wide area network (WAN), a local area network (LAN), a public network, the Internet, etc., enables system 100 to communicate with external components, to exchange data with the external components, to access and connect to network resources via a network 108.

With further reference to FIG. 1B, each user device 104 includes a user transaction application, such as a digital wallet, and a user interface 122. The user transaction application 120 is coupled to the user interface 122 for receiving user input and outputting information to the user, such as via a GUI or other user input and output devices of user device 104. The user devices 104 can be mobile or stationary computing devices, such as smart mobile phones, laptops, desktop computers, tablets, a server (e.g., of a payroll processor, financial institution, company disbursing payments, etc.).

The user and the digital wallet register to be enrolled and authenticated with the transaction server and associated with a financial account having an associated source account number that is hosted by a financial institution that has an associated source routing number.

The user can interact with the user transaction application 120 via the I/O interface 122, e.g., using the GUI, to request a transaction, including providing a value of the transaction (an amount of money to be sent) and identifying a destination account to which the money should be sent. The different account has an associated destination account number and is hosted by an institution having a destination routing number.

In response to the user actions, the user transaction application 120 generates a transaction request. The transaction request includes the value of money to be transacted, the source identifier (e.g. routing number and account number) and the destination identifier (e.g. routing number and account number).

Additionally, the transaction request can include other transaction parameters, such as payment time and/or a user-selectable optimization parameter that specifies a characteristic to use for optimizing the transaction. Examples of optimization parameters include speed and cost. The selected optimization parameter, also referred to as intent data, can be indicated in the transaction request using a flag or the like.

The transaction requests can include a request for a single transaction or multiple transactions. In some embodiments, the transaction request can include a computer file that includes multiple transactions. The computer file can use various formats, such as any of comma-separated values (CSV), Excel®, National Automated Clearinghouse Association (NACHA)® formats, etc.

The user transaction application 120 includes an API and can receive API messages from the transaction server 102, such as about the status of the transaction request. The user transaction application 120 can cause information about the transaction request and feedback from the transaction server 102 to be communicated to the user via the user interface 122, e.g., using the GUI.

The user interface 122 can communicate with one or more input components of user device 104, such as a keyboard, mouse, camera, touch screen and a microphone, or with one or more output components, such as a display screen and a speaker.

With further reference to FIG. 1C, transaction server 102 includes a bidding engine 130 that includes a route selector 132 that accesses or stores optimization routing rules 134 as well as current bids and/or contracts 136. Transaction server 102 includes one or more APIs for communicating with external applications. The APIs can be combined or separated into multiple APIs, such as transaction request interface 140, external bidding and/or contract interface 142, routing request interface 144, and routing return or failure interface 146. Transaction server 102 can include one or more models, including routing model 150 and/or content model 152.

Routing model 150 and/or content model 152 can be statistical models, mathematical models, probabilistic models, trained ML models, etc. In one or more embodiments, transaction server 102 can also operate in a training mode to train the ML models.

Transaction server 102 further accesses or stores collections or repositories of information 160, such as a transaction ledger 162 that includes transaction historical data 164, enrolled user data 166, and enrolled payment route data 168. The historical can include data collected while monitoring previous transactions, such as observed return times.

Transaction request interface 140 is configured to receive transaction requests from entities requesting a transaction, such as a user device 104. The transaction requests can be received in real time and processed by bidding engine 130. Transaction request interface 140 can also send messages to the user devices, such as confirmation of receipt.

The transaction request can be an API message submitted by an enrolled user transaction application 120 executing on a user device 104 to the transaction server 102 via an API call.

The transaction server 102 is configured to access the transaction information from the transaction request, including source and destination identifiers (e.g., routing number and account number for the respective source and destination) and a transaction amount. Additionally, the transaction server 102 is configured to access any transaction parameters that may be included in the transaction request, such as payment time and/or a user-selectable optimization parameter that specifies a characteristic (e.g., cost and/or speed) to use for optimizing the transaction. Additionally, the transaction server 102 is configured to handle all requests included in the transaction request, including a single transaction or multiple transactions, such as provided via a computer file, e.g., in a format such as CSV, Excel, NACHA formats, etc.

In certain embodiments, external bidding and/or contract interface 142 is configured to receive contracts or bids from e.g., administrative entities of parties included in a transaction routes 106 that transaction server 102 can use for routing transactions The contracts and external bids can be submitted at any time. They can be submitted one time or at intervals and in effect until it expires or is changed, or they can be submitted in real time. Such contracts and external bills can be between the submitting entity (e.g., that administers any of the parties in the transaction routes 106) and the entity represented by the transaction server 102 and/or between the submitting entity and one or more users. Current external bids and/or contracts 136 are submitted external bids or contracts that are currently in effect. The current external bids and/or contracts 136 are accessed and/or stored by the route selector 132. External bidding and/or contract interface 142 can also send messages to the administrative entities, such as confirmation of receipt.

Routing request interface 144 is configured to prepare and send the selected route routing requests to the selected payment route. The routing requests include transaction information. Routing request interface 144 can include a translator 148 configured for translating and/or enhancing the transaction information, e.g., into a different format and/or with enhanced information. Routing request interface 144 can also receive messages from the provider or payment rail of the selected payment route, such as confirmation of receipt or failure messages indicating the occurrence and type of a failure routing the transaction, or a return message indicating the occurrence and type of a return of the transaction. The failure and return messages enable route selector 132 to monitor transactions in real time for failures or returns.

Ledger 162 stores data about each transaction and can be updated with details about each transaction request and routing request. Historical transaction data 164 can store data about individual or groups of transactions, payment rails and providers individually and/or in different combinations. In certain embodiments, the ledger 162 can include the historical transaction data 164. Information can be stored for different payment routes (including paired payment rails and providers). The information can include statistics about returns and failures. For example, the historical data for a particular payment route can include failure data about past occurrences of failures or returns that occurred when using the payment route for past transactions, speed of routing respective past transactions using the payment route, and cost incurred for using the payment route for routing past transactions.

Enrolled user data 166 can include data about each user and services that the user is enrolled to use, such as which payment rails and providers can be selected for that user. Enrolled user data 166 can include information for authenticating the users, information about contracts into which the user has entered, and/or details that can be used, for example, to form routing requests.

Enrolled payment route data 168 can include information about a collection of payment routes, including information about individual payment rails, individual providers, and pairs of payment rails and providers. Enrolled payment route data 166 can include information for authenticating the provider or payment rail of the respective payment routes.

Routing request interface 144 is further configured to receive return or failure messages from the selected payment route that notify about the occurrence of a return or a failure. Routing request interface 144 is configured to respond to a return or failure message by sending a recovery message to the route selector 132 to inform the route selector 132 of the return or the failure. Route selector 132 can use the recovery message to update the transaction historical data 164 with information about the return or failure and/or to select a different payment route.

Route selector 132 receives transaction requests and accesses data in the collections 160 to select a payment route. Route selector 132 can further apply the optimization routing rules 134 for selecting the payment route. The optimization routing rules 134 can be based on, for example and without limitation, math, statistical, and/or probabilistic methods. The optimization routing rules 134 can be deterministic or non-deterministic. The route selection is provided to routing request interface 144 for submission of a routing request to the selected payment route, such as to a server of the provider.

In some embodiments, the route selector 132 uses the routing model(s) 150 to configure the optimization routing rules 134 for selecting an optimized payment route.

In one or more embodiments, route selector 132 first identifies a plurality of payment routes that are compatible as being potentially suitable for the transaction and orchestrates for the compatible payment routes to bid against each other to be the selected payment route. The selection can be selected directly from the collections 160 or from a subset of the payment routes obtained from the collections 160.

The process of selecting the payment route can include creating and evaluating bid callouts. The bid callouts can include one or more bid scores for candidate payment routes of the plurality of payment routes stored in the enrolled payment route data collection 168. The candidate payment routes can be for only the payment routes that are compatible. This rules out the burden of creating bid callouts for incompatible payment routes and reduces consumption of computing resources, such as processing and storage.

Route selector 132 can assign the bid scores based on the transaction historical data 164 and optimization routing rules. The optimization routing rules can be deterministic rules based on, for example and without limitation math and statistics. The rules can be non-deterministic. The rules can be determined or applied using routing model(s) 150, which can include using machine learning. The bid scores can be based on predicted cost and/or speed of routing the transaction using the respective candidate payment routes.

In certain embodiments, external bidding and/or contract interface 142 receives dynamic (e.g., that can be received at any time, including in real time or near real time) external bids associated with usage of respective payment routes of the plurality of payment routes. The bids can be received in real time. An auction style process can be used to request external bids, e.g., for one or more particular transactions. The bids can be directed to a specific transaction or multiple transactions that are treated as a group. A bid can last for a specific time period, such as for creating a flash sale the terminates at the end of the time period. Creating the bid callouts can include determining effects of the received dynamic external bids on the transaction for the respective compatible payment routes. The payment route is based on the determined effects.

In certain embodiments, external bidding and/or contract interface 142 receives contract data representing contract terms of a contract between the payment route and the user and/or contract terms of a contract between the different enrolled payment routes and the routing selection system. The contract data can be received in real time or near real time or can be received at a past time and stored. The contract can be temporary, such as for a prescribed time period, or permanent. The contract can be negotiated and updated. Current data about the contract ca be stored in current bids and/or contracts storage 136, which can be accessed by route selector 132. Creating the bid callouts can include an evaluation of application of the contract terms to the plurality of payment routes or the compatible payment routes. Alternatively or additionally, selecting the payment route can be based on an evaluation of application of the contract terms to the compatible payment routes.

In embodiments in which the transaction request includes an optimization selection, selecting the payment route is optimized based on the optimization selection.

In some embodiments, the route selector 132 is notified about and monitors in real-time or near real-time the routing of the transaction via the selected payment route for the occurrence of a failure in association with a payment route, and depending on the type of failure, does not select the associated payment route or re-routes the transaction using a different payment route.

In some embodiments, route selector 132 can calculate a probability and speed of returns per-institution and per-routing-number and uses this information for selecting the payment route in order to make funds available earlier and with less risk. For example, after a certain number of return transactions from a particular routing number, route server 132 can calculate an average return time for returns from that routing number and can base funds availability on the average return time. In some embodiments, the funds availability is varied based on e.g., the return type, routing number, and the institution. By basing funds availability on actual observed return time, rather than by merely applying network rules, route selector 132 can treat funds as being available faster without incurring additional risk.

In one or more embodiments, the route selector 132 selects the payment route using historical data and optimization routing rules 134. The historical data can include actual observed return times.

Route selector 132 monitors transactions in real time for failures or returns, such as based on receipt of the failure and return messages via routing request interface 144. Route selector 132 can log the occurrence of detected failures or returns in the transaction historical data 164 and/or can decide to trigger an intervention due to the failure.

When intervening, route selector 132 can repeat the process of selecting the payment route and select a revised payment route from the plurality of payment routes stored in enrolled payment route data 168 and route the transaction to the revised payment route as a failover routing request.

Route selector 132 can use routing model 150 to analyze the historical data and select a payment route. Routing model(s) 150 can apply machine learning and use, for example, a linear regression with weights calculated from the transaction historical data 164, a clustering algorithm, a large language model (LLM). Routing model(s) 150 can be trained, for example, using historical data that includes payments routes used in different scenarios and data about actual cost, returns, failures, and timing.

Using an example to illustrate, route selector 132, optionally using routing model(s) 150, can identify from data collections 160 that for ACH pull transactions, some routing numbers from some banks reliably report return errors R01/R02s within one business day as compared to the ACH system requirement of three business days. Route selector 132 can decide to make funds from those routing numbers available to clients (also referred to as users) in one business day rather than waiting for three business days. In this way, lengthy transactions that can take up to three business days are avoided, the user receives results quickly and reliably. The faster completion of the transactions reduces the number of transactions that are pending, which reduces a volume of data that the transaction server handles or monitors while the transactions are pending.

ACH transactions take one to multiple business days to reach their destination accounts, and providers deal with this by setting standard times to credit accounts.

In an example scenario, Bank of A submits a client's ACH debit transactions on Day 1, and if Bank A does not receive an error back from the destination institutions, the client's account can be credited on Day 4.

Route selector 132 can have more-granular control of funds availability using data included in the historical data, which can include data on return timing by routing number, return type, transaction type, institution, etc.

To illustrate, in an example scenario, route selector 132 can submit Client B1's ACH debit of a source account at First Bank of B on Day 1 for payment to a destination, Client B2. Route selector 132 calls on the routing model(s) 150 to determine a probability of a return based on historical data and information about Client B1's account and routing numbers as well as other factors. The other factors can include, for example, the size of the transaction, the type of the transaction, the time, date, and day of the week of submitting the transaction request, Client B2's routing number and institution, additional information about the Client B1, such as risk scores calculated based on client and transaction information (e.g. know your customer (KYC) and personally identifiable information (PII) information) associated with the Client B1, and biometric information collected from Client B1's personal computing device such as a smartphone or laptop, e.g., for purposes of authorization.

The routing model(s) 150 process the transaction request and data collections 160 to compute output results, such as return probabilities. The routing model(s) 150 can access and use historical data for all transactions with similar characteristics and factors as the current transaction to generate the output results. The output results can indicate, for example, that after two business days, there is a 95% chance there will not be a return. Therefore, transaction server 102 can credit the client's account after two business days and make funds available for processing the transaction.

Route selector 132 can also track the overall rate of returns per institution for use in optimizing for utilization of resources (also referred to as cost) and reducing or minimizing risks. A higher risk of returns also indicates a higher probability of slow routing of a transaction For example, if the overall rate of returns on ACH debits made from accounts at National C Bank is 4%, route selector's 132 selection of National C Bank would likely result in a longer time to make funds available and would thus is more likely to be slower for routing the transaction compared to using First Bank of B, which has an overall return rate of 0.5%.

Route selector 132 can use the transaction historical information 164 (and optionally routing model(s) 150) to predict and compare, as a function of overall return rates, the amount of time it will take and/or cost incurred for using different payment routes (including for different institutions, routing numbers, and/or account numbers) to successfully route a transaction. The predicting can use data from historical transactions information 164 that is relevant, for example to the source and/or destination identifiers for the transaction for generating or revising optimization routing rules. This can provide an advantage over institutions that route a transaction by applying the same network rules to all transactions without being aware of or taking into account a past history of long return rates. The disclosed route selector 132 is thus able to select a payment route that will result in faster availability of funds, even days by days, as compared to other payment routes that might have been selected without applying the knowledge obtained from the transactional historical data while using a one-size-fits-all-transactions policy.

A score can be generated that reflects, for example, the predicted risk of return and speed of the payment routes that were analyzed. In some embodiments, depending on the client, this scoring can also be used by transaction server 102 for calculating reserve account amounts, thus reducing or minimizing the money a client has to keep on hand with the financial institution. In some embodiments, bidding engine 130 can use this scoring to calculate the costs to offer a different product for providing immediate availability of funds being transacted, reducing or minimizing the cost to the user for this extra service. In some embodiments, a favorable bid score for a particular payment route for the particular transaction can be used by route selector 132 to calculate partial funds availability (e.g., making a portion (e.g., 95%) of funds available after a first time period when debited from the routing number designated in the destination identifier, with the remaining portion of the funds being available after a second time period that is longer than the first time period.

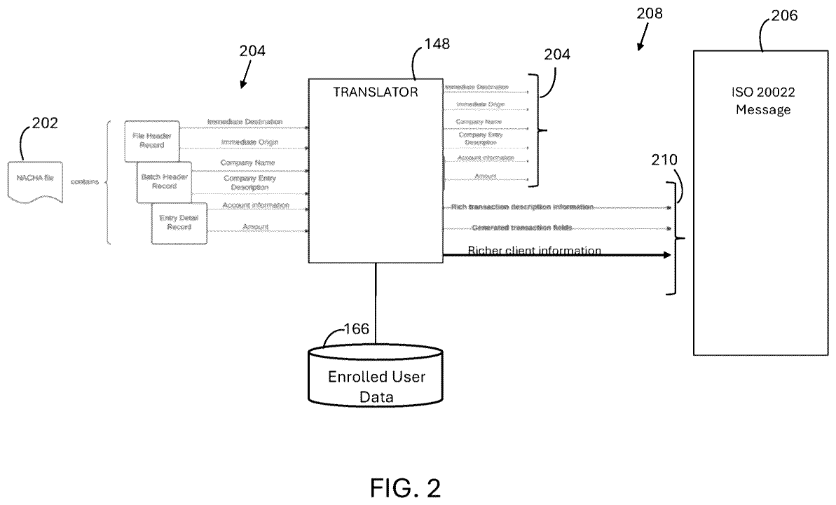

With additional reference to FIG. 2, an example is shown in which a transaction request 202 is received by transaction server 102 via transaction request interface 140, wherein the transaction request has a first format that includes fields for first data 204. Once transaction request 202 is processed and a payment route is selected, the transaction request is reformatted into a routing request 206 and transmitted to the selected payment route. The selected payment route may not recognize messages having the first format and may require that all messages have a second format having fields for second data 208. In the example shown, the transaction request is formatted as a NACHA file having first data 204, and the routing request is formatted as an ISO 20022 message having second data 208. Translator 148 translates the transaction request having the first format into routing request having the second format.

In some embodiments, translator 148 can transform transaction data from one payment system that uses the first format (e.g. payment rail) to another payment system that uses the second format and is more advanced and/or more data intensive. Translator 148 can perform this transformation by expanding data that is available in the first format into the second format, such as by extracting data from collection 160 and/or making inferences. Translator 148 an apply one or more content models 152 for making the inferences.

In accordance with the example, second data 208 needed for fields of the second format used by the ISO 20022 message of the routing request 206 include first data 204 that is included with the NACHA file used by the routing request 206, but additional data 210 is needed for formatting the ISO 20022 message of the routing request 206. Translator 148 can extract data 204 from the translation request 202 and use it to populate the routing request 206. Additionally, translator 148 generates the additional data 210 and uses it to populate the routing request 206. In the example provided, the additional data 210 that is inserted in the routing request 206 includes rich transaction description information, generated transaction fields, and richer client information.

Translator 148 can apply routing rules extract client data from collections 160 to generate the richer client information. Populating the routing request 206 with the extracted data and additional data can include mapping data, padding data, and adding data that is missing by finding data, combining data that was found (e.g., including performing calculations or logic operations), and/or inferring the missing data. For example, translator 148 can determine the additional data by calculating information based on client data and/or use-case data available in collections 160 and using defaults that may be applicable. Translator 148 can use methods for locating information, such as by using lookup tables to interpret information.

In one example, translator 148 looks up the meaning of a code (e.g., a code that refers to a subscription charge for a service) and then translates the information into a plain English description field used by the second format. As another example, translator 148 applies content model(s) 152 for using machine learning. Using the transaction historical data 164, content model(s) 152 can be applied to make high-certainty predictions or estimations for use in the additional data 210. If predictions are rejected (e.g., by user feedback or a system error), the feedback can be used to improve or tune the content model(s) 152. Alternatively or additionally, translator 148 can use generative artificial intelligence platforms, e.g., using LLMs for predictions. Content model(s) 150 can be trained, for example, using historical data 164, enrolled user data 166, publicly available data, previous inferences, success and failures of previous inferences, etc.

Content model(s) 152 and translator 148 and routing model(s) 150 and route selector 152 can use a classification system that uses probabilistic techniques. Content model(s) 152 and routing model(s) 150 can be a trained supervised model. In different embodiments content model(s) and routing model(s) 150 can use a neural network, a Bayesian network, decision trees, probabilistic techniques, and/or a deterministic classification method that uses a fixed ruleset.

For example, translator 148 can predict that there is a 48% chance that a payment directed to “EXAMPLE AUTO” is for an auto loan repayment and a 30% chance of being a payment towards an automotive insurance premium. Using this information, translator 148 can populate a field for industry category in the second format as “auto loans.” If the transaction is rejected with a relevant error code, this feedback is used to adjust weights for tuning content model(s) 152 so that future similar transactions would be more likely to use “insurance premium” in the field for industry category. Translator 148 can also log that for the particular combination of inputs in the rejected translation of the transaction request, “auto loans” has been found not to work, and should be excluded from the set of potential values to be adopted.

Adjusting weights and setting exclusions can be automatic, with the automation overseen by selectable overriding criteria-based rules that can be applied to override certain weight adjustments. For example, if translator 148 learns that Bank of Byzantine rejects all transactions that are identified as a down payment or final payment, but accepts all transactions identified where it is set as “down or final payment,” then transaction server 102 may not consider either down payment or final payment as options, and would not use Bank of Byzantine's acceptance of transactions as an input for predicting payments to other institutions.

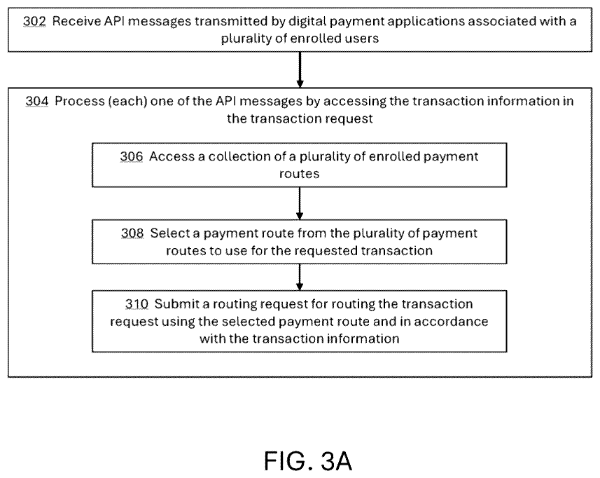

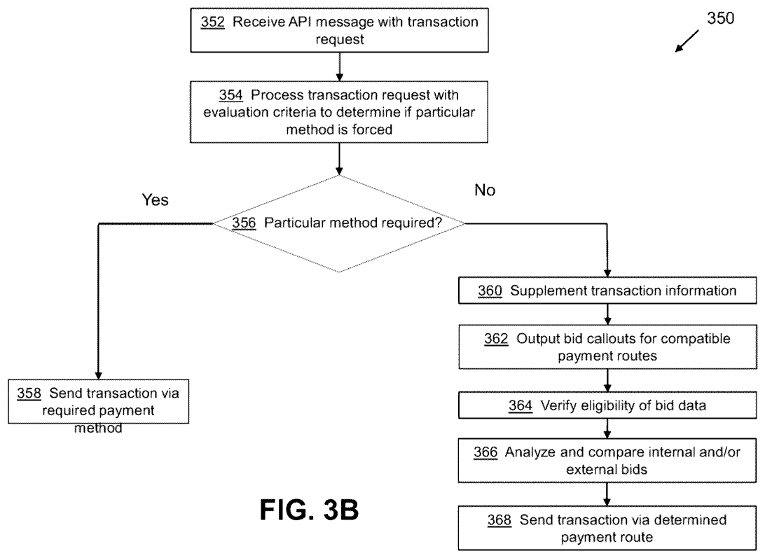

With reference now to FIGS. 3A and 3B, shown are flowcharts demonstrating implementation of the various exemplary embodiments. It is noted that the order of operations shown in FIGS. 3A and 3B is not required, so in principle, the various operations may be performed out of the illustrated order. Also certain optional operations may be skipped, different operations may be added or substituted, some operations may be performed in parallel instead of strictly sequentially, or selected operations or groups of operations may be performed in a separate application following the embodiments described herein.

FIG. 3A is a diagram a process 300 for payment routing in accordance with certain embodiments of the disclosure. The process 300 can be performed by a transaction server, such as transaction server 102 shown in FIGS. 1A and 1C. The process 300 can include selecting routes, determining bids, applying optimization rules, applying external bids or contracts, and/or applying models that can apply AI techniques and that may be trained using machine learning techniques. The external bids and/or contracts can be received by the transaction server in real time.

At 302, API messages that were transmitted by digital payment applications associated with a plurality of enrolled users are received. Each API message includes one or more transaction requests from one of the users requesting a transfer of funds. The transaction requests can be included in a computer file that can be in various formats, including, but not limited to, CSV, Excel, or NACHA formats. Each transaction request includes transaction information that includes a value of the funds requested to be transferred, a source identifier, and a destination identifier. In one or more embodiments, the API message can include intent data for application or one or more of the transaction requests.

At 304, one of the API messages received is processed. Transaction information in the corresponding transaction request is accessed. At 306, a collection of a plurality of enrolled payment routes is accessed, such as enrolled payment route data 168 shown in FIG. 1C. Each payment route of the plurality of payment routes includes a different combination of a plurality of payment rails and a plurality of payment providers for routing the transfer request. At least one of the payment rails of the plurality of payment rails is combined with different respective payment providers of the plurality of payment providers.

At 308, a payment route is selected from the plurality of payment routes to use for routing the requested transaction.

In one or more embodiments, the payment route can be selected using predictions about cost and/or speed for routing the transaction based on the transaction historical data. In one or more embodiments, the payment route can be selected based on an evaluation of effects of received external bids on routing the transaction for the respective compatible payment routes. The payment route can be selected based on is based on an evaluation of application of contract terms to the plurality of payment routes and/or to the compatible payment routes. In one or more embodiments, selecting the payment route is optimized based on an optimization selection specified with the transaction request, wherein the optimization selection specifies a characteristic to use for optimizing the routing of the transaction request, the characteristic being selectable from cost for routing the transaction and speed of routing the transaction request.

At 310, a routing request is submitted for routing the transaction per the transaction request using the selected payment route and in accordance with the transaction information.

FIG. 3B is a diagram of a process 350 for payment routing in accordance with certain embodiments of the disclosure. The process 350 can be performed by a transaction server, such as transaction server 102 shown in FIGS. 1A and 1C and can use a route selector, such as route selector 132, to select routes, determine bids, apply optimization rules, apply external bids or contracts, apply models that can apply AI techniques and that may be trained using machine learning techniques according to embodiments described herein.

At 352, API messages that were transmitted by digital payment applications associated with a plurality of enrolled users are received. Each API message includes one or more transaction requests from one of the users requesting a transfer of funds. The transaction requests can be included in a computer file that can be in various formats, including, but not limited to, CSV, Excel, or NACHA formats. Each transaction request includes transaction information that includes a value of the funds requested to be transferred, a source identifier, and a destination identifier. In one or more embodiments, the API message can include intent data for application or one or more of the transaction requests.

At 354, transaction server 102 processes a received transaction request with evaluation criteria to determine if the transaction request requires a particular method for being processed (also referred to the method being forced). The evaluation criteria can include a determination whether characteristics of the transaction request force a particular method. For example, a transaction request that includes a NACHA file having minimal data for bank-to-bank transactions, application of the evaluation criteria can include a simple application of predetermined rules or a lookup process by which it can be determined that the destination bank only participates in traditional ACH transactions that use an ACH network, leaving only one option for sending that transaction request.

As another example, the transaction request can include a well-formatted and complete request for a card transaction. Application of the evaluation criteria can include a simple application of predetermined rules or a lookup process by which it can be determined that the transaction request cannot be sent via bank-to-bank networks and must be sent via that card's specific network.

As another example, application of the evaluation criteria can include determining whether providers that are available for the transaction are capable of satisfying transaction criteria included in the transaction request, such as time-and-date-bound requirements. The evaluation criteria used by the transaction server 102 can include whether a particular payment route: is performant, can meet a transaction deadline, is able to support the transaction submitted, etc.

Technical integration status (e.g. implementation of new capabilities offered by a provider in a development, testing, or production environment) can also be evaluated and confirmed during this initial evaluation.

At 356, a determination is made whether a particular payment route (also referred to as a payment method) is required. If it is determined that a particular payment route is required, at 358, the transaction request is sent via the required payment route, thus saving the processing cost, memory consumption, processing and/or transmission bandwidth consumption, and/or system latency that can arise due to performance of data enrichment and/or determination of different routing choices.

If it is determined that a particular payment is not required, the method continues at 360. At 360, transaction server 102 supplements the transaction information. The supplementation of data can be used to determine compatible payment routes. As an example, the transaction request can indicate: “client gives us instructions to send $200 to Example Bank, account #1, needs to arrive within 24 hours.” Transaction server 102 determines in the initial check that Example Bank is a member of different networks, and so is worth processing further. Transaction server 102 performs data supplementation, and the transaction data can indicate that this is a recurring bill payment. Sources of information from which the data for data supplementation can be obtained include data collections, such as data collections 160 shown in FIG. 1C, and/or accessing online public or proprietary sources, such as a search engine or LLM.

In this example additional supplemental data sought can include available options that can be used for sending a transaction that is a recurring bill, and which requires that the payment must arrive at Example Bank within 24 hours. Options returned are the following compatible payment routes and their corresponding cost:
ProviderA-Sameday ACH, $1
ProviderB-FedNow, $2
ProviderC-RTP, $3

For this example, all other characteristics of the available payment routes are equal. At 357, the transaction server scores them and declares that ProviderA-Sameday ACH is the way to go and sends it off via that network.

At 362, the transaction server outputs a bid call out for the respective compatible payment routes. The transaction server then creates bids for each potential payment route and provider based on the available payment routes determined in response to the call out. The creation of bids can be determined based on various factors, including client contract considerations. As the provider of services to many clients, during bid creation, the transaction server can optimize client traffic to reduce or minimize cost (for example, by attempting to use any transactions included in a client's contracts by using included transactions first and distributing transactions between pools of included transactions where possible), and/or for load balancing. The transaction server can also implement a method that considers potential value saved during bid creation. The transaction server can accomplish this by, for example, allowing allocation of some unused fast transactions included in a client's contract to be used for regular (e.g., slow) transactions as the end of a month (or other contracted period) approaches, or by using tiered pricing where other types of discounting is activated based on transaction volume or other factors. The transaction server can also include other contract considerations in the bid creation process, such as progress against projected and/or predicted volumes in client contracts or in contracts above the client level. For contracts above the client level (e.g., at the server level), incentives offered by partners or payment routes or other considerations can be potential factors resulting in a particular bid or set of bids being discounted during bid creation.

In some embodiments, the bid call outs are internal to the transaction server and are processed internally for creating a bid for the respective bid call outs.

In some embodiments, the bid call outs are made external to the transaction server. For example, the external bid call outs can be sent to providers or payment routes, e.g., via APIs, and the providers or payment routes can respond in real time to the external call outs with new or updated offers (also referred to as bids). This can establish a live auction scenario. The external bids can be per transaction or can be to all or groups of transactions or users. The external bids can be in effect for a specified time period.

A provider or payment route can respond to the external bill call outs by setting terms for their external bids (e.g., the external bids can be available in general to all clients or to a specified subset of specific clients). The terms of the external bids can be set automatically or manually, e.g., by a provider or by an administrator of the transaction server, e.g., in response to receiving a contract or pop-up sale offer from a provider. Terms for the external bids can be set to take effect immediately or at a future effective date. For example, the external bid terms can be updated by a provider through use of an administrative console, at frequency of provider's choosing, or by the administrator of the transaction server.

The transaction server can support a live auction by sending, an API call to all or certain providers or payment systems as a request for external bids that will establish current pricing available for the current transaction and/or future transactions. The request for external bids can be sent out at any time. In response the transaction server can receive from providers and payment routes real time external bids that include live terms and/or pricing.

In an example scenario, a transaction request is received at 352 for a payment to be made to a specified bank account. The transaction server determines that the payment options currently available to the client are Provider-Method A for $3 and Provider-Method B for $5. The transaction server calls out at 357 for additional providers or payment routes to check on real-time pricing. A provider returns that it will make Provider-Method C available for $1. At 357, the transaction server adds Provider-Method C as an available option and returns as bid data all of the available payment route options, whether as responses to internal or external bid call outs.

At 364, the transaction server directs verification of eligibility of the bid data created for each of the potential available payment routes. This can include reprocessing the bid data at 354 to confirm the eligibility of each of the bids.

At 366, the transaction server analyzes and compares the internal and/or external bids. A winning bid is selected based on a result of the comparison. The comparison can include assigning scores to the internal and/or external bids. One or more factors can be used to weight a score and/or used to make a selection of a payment route in the event of a tie on the bid price. The factors can as applied to the compatible payment routes include, for example and without limitation, transaction arrival time, historical performance of, probable failure rate, normalized availability, normalized performance, contract considerations (e.g. client-level contract considerations or server-level contract considerations), client preference, optimization of client traffic, potential value saved, available volume discounts, lowest overall cost (e.g. monthly cost to client), projected and/or predicted routing time, incurred risk, whether to optimize for speed or cost, projected and/or predicted volume of transactions that have the choice of the same payment route, partner incentives, etc. The winning bid is used to select the payment route that will be used to route the transaction.

Transaction server can use different methods for scoring during bid price tie-breaking. In certain embodiments, transaction server can rank bid prices in tie-breaking scenarios per-client-preference and can check each in turn until a winner is determined. In certain embodiments, a client can choose a weighting of factors and transaction server can average those weights to determine a winner.

In an example of ranked tie-breaking: A client transaction is priced for both Provider-Method A and Provider-Method B at $0.04. Included in the returned information about routing options is that the client has specified that for tiebreaking they wish to select a payment route based on a determination of: (i) normalized failure rate; (ii) normalized transaction time.

Normalized scoring for probable failure rate for both payment routes is 100, while normalized average transaction time for Provider-Method A is 95, and for Provider-Method B is 100. The transaction server evaluates probable failure rate as a tie, moves to evaluating average transaction time, and declares Provider-MethodB as the winner.

In an example of weighted criteria tie-breaking in which a client has specified they wish ties to be broken based on an average of (i) normalized failure rate; (ii) normalized transaction time, normalized scoring for probable failure rate for both payment routes is 100, while normalized average transaction time for Provider-Method A is 95, and for Provider-Method B is 100. The transaction server averages the two normalized values to determine Provider-Method B having an averaged, normalized score of 100 is the winner over Provider-Method A having an averaged, normalized score of 97.5.

At 366, the transaction server sends the transaction via the determined payment route by sending a routing message using an API.

Summarizing the evaluation process with returned reference to FIG. 1C, transaction server 102 can process a transaction request received from a client by determining which payment routes are available for a client as well as which payment routes are currently available for the transaction.

The transaction server 102 can use evaluation criteria to make this determination of payment routes that are currently available for the transaction. Example evaluation criteria include: A determination whether the method (e.g., payment route) is currently available and performant; a determination whether the client submitting the transaction is able to use that method (e.g., whether the client have agreements in place with the transaction server 102 and the providers. A determination whether the method is enabled in a relevant production environment.

The transaction server 102 can use evaluation criteria to determine routing to the appropriate payment route available for the transaction. Example evaluation criteria can include: a determination whether the transaction request for an RTP transaction; a determination as to which providers and payment routes can serve this RTP transaction; a determination whether the transaction server 102 can generate responses based on evaluation criteria, such responses containing, for example: a list of payment routes available to be sent that are normally eligible (e.g., the client has contracts in place with particular providers for particular payment routes) and/or a list of payment routes available to be sent, with currently non-performant options not included in the list (e.g., if payment route ACH-Sameday-ProviderA is not currently non-performant, then payment route ACH-Sameday-ProviderA would not be returned and is included in the list).

The transaction server 102 can store past performance data for transactions sent by a particular payment route. Transaction server 102 can store data about how transaction server 102 determined whether a payment route can be used at all. Transaction server 102 can use the stored data for comparative purposes.

For each payment route, transaction server 102 maintains performance data for transactions sent via that payment route. For example, transaction server 102 can log data indicating whether the transaction succeeded or failed at the payment route level. If the transaction succeeded, transaction server 102 can log data indicating the total time for that transaction to return on the network. Transaction server 102 can log data indicating transaction type.

To determine whether a payment route is to be considered available, transaction server 102 can set an expected transaction failure rate for the payment route. In some embodiments, if more than a threshold (e.g., wherein the threshold indicates a statistically unlikely number) number of transactions fail, the transaction server 102 can set that payment route to “not available” and an alert can be generated and sent. The number of transactions can be, for example, a number of consecutive transactions or a percentage of transactions over a time frame.

### Examples

As an illustrative example, assume that during normal operation a payment route has an error rate of 1%. The transaction server 102 can set a limit, for example of 10% errors over a given time frame or sample size. When the limit is exceeded, transaction server 102 can trigger an internal alert that is configured to enable execution of escalation services, for example. Additionally, transaction server 102 or the escalation services can also tag the payment route as being “degraded” and disable it or cause it to have a timeout (meaning to be paused for a time interval) on the occurrence of further errors. The time interval used for the timeouts can be progressively increased with each successive occurrence of an error (e.g., from 1 m to 2 m, and then to 5 m, etc.

For example, transaction server 102 can determine that a payment route using Method ACH-Sameday-ProviderA has a “normal” failure rate of 4% and is set to alert when the probability of consecutive failures occurring by chance is <0.001%. Transaction server 102 can receive four consecutive failure messages when trying to route a transaction via this payment route. Transaction server 102 can compute that there is a <0.0001% of this occurring by chance, so the payment route is tagged as being unavailable and an alert is sent.

As another example, transaction server 102 can determine that the payment route Method ACH-Sameday-ProviderA has a “normal” failure rate of 4% and is set to alert when the number of failures occurring in a given time interval by chance is <0.001%. Over a five-minute time period, transaction server 102 detects that four out of 100 transactions failed, without any being consecutive. Transaction server 102 can indicate that the payment route remains available.

In some embodiments, transaction server 102 can compute a score for evaluating payment routes. To create a score used in determining which payment route to use when there is choice available, transaction server 102 can use, for example, Equation (1).

$$α = W ( A ) \times ( Normalized availability ) + W ( P ) \times ( Normalized performanced ) \qquad Equation 1$$

where α is the score, W is a weight (each W can be assigned individually), A is measured availability, P is measured performance, and Normalized availability is determined using Equation (2.1) and Normalized performance is determined using Equation (2.2):

$$( Measured Availability - Minimum Acceptable Availability ) / Maximum Acceptable Failure Rate \qquad Equation 2.1$$

For example, if payment route Method ACH-Sameday-ProviderA operates with a 96% success rate, and the acceptable low success rate for the corresponding payment rail is 95% and the maximum acceptable failure rate for the payment rail is 5%, then the transaction server 102 can compute:

$$( 96 \% - 95 \% ) / 5 \% = 0.2$$

Similarly, the transaction server 102 can normalize performance, with lower scores indicating better performance, where normalized performance is:

(Measured Performance−Minimum Acceptable Performance)/Average Performance Equation 2.2:

For example, if the payment route Method ACH-Sameday-ProviderA operates with a speed of 300 ms and the minimum acceptable performance for the corresponding payment rail is of 100 ms, and the average performance for that payment rail is 200 ms, then the transaction server 102 can compute:

$$( 300 - 100 ) / 200 = 1$$

Weights for determining an overall score based on availability and performance can be tuned by the transaction server 102 to reflect a client preference. For example, for a client who puts a premium on ensuring transaction success, the transaction server 102 can choose a weight for availability of 10 and 1 for performance, while one seeking speed and willing to overlook reliability might weight availability at 3 and performance at 1. Client preference can also include routing preference, such as a client preference for RTP as a payment rail over FedNow.

For example, Client NewCo wishes to send instant transactions and has both FedNow and RTP available to them and Client NewCo has an expressed preference for using RTP as a payment rail over FedNow. Client NewCo's preference is stored as a preference value by the transaction server 102 at the client level in the collections 120. Clients can also adjust their preferences via the user interface provided by their payment application. For example, the client's preference value for a particular payment rail can be a value as low as one cent, to break zero ties, or as any higher value. In this way, when the transaction server 102 is providing bidding prices for an auction of payment routes, payment routes included in the auction bids that include RTP are discounted by the client's preference value for purposes of the transaction server 102 selecting the winning bid and how the transaction is routed.

For example, Client NewCo sends an instant transaction request destined for Bank of B, which participates on both RTP and FedNow. The transaction server 102 stores a preference value of $0.01 for RTP for Client NewCo per the client's preference value as selected by Client NewCo. In the example, the price determined for Client NewCo's transaction, without preference, is $0.50 for FedNow-ProviderC and $0.50 for RTP-ProviderC. When adjusted based on Client NewCo's preference value, transaction server 102 selects RTP-ProviderC as the winner of the auction based on a $0.49 bid price as adjusted using Client NewCo's preference value of $0.01 for RTP.

The client preference and weighting can be set in many different ways, for example, as a global setting and/or provided on a per-transaction basis. If set on a per-transaction basis, the transaction server 102 is tuned based on the preference specified by the client as part of a specific transaction request received by the transaction server 102.

The transaction server 102 can record the results of processes that include the application of client preferences and weightings as data for future use that can benefit the client. The number of times a client preference was applied, and how often the client preference changed the outcome of an auction can be reported to the client. The transaction server 102 can also report to the client the costs associated with applying client preferences.

For example, if Client NewCo's preference of $0.01 for RTP was applied 5,000 times in a reporting period by the transaction server 102, the transaction server 102 can report to Client NewCo that the preference incurred a cost of $50.00 during that reporting period.

In some embodiments, transaction server 102 can store client enrollment data per payment route. Transaction server 102 can maintain for each client a set of what payment rails and providers are available to them. The payment rails may be available based on the client's agreements with providers of transaction server 102 and partners of transaction server 102, the state of client's integrations, and other factors.

For example, Client NewCo may have signed an agreement with ProviderA, but not yet completed a technical integration in development environments to use the new capabilities provided by ProviderA. The client's enrollment data will indicate that ProviderA is not available to the client and a “ProviderA enabled” value will not be included in the client enrollment data. Therefore, ProviderA is considered to not be a compatible payment route for the client, and payment routes that include ProviderA will not be priced for the auction or made available to transaction server 102 to use for routing.

As another example, Client NewCo, already a user of the FedNow network through ProviderA, wishes to add another payment route: FedNow-ProviderC. Client NewCo makes appropriate agreements with transaction server 102 and ProviderC. Transaction server 102 marks Client NewCo as able to use ProviderC and the payment route FedNow-ProviderC. Payment routes that include ProviderC will now be priced for the auction and are available to transaction server 102 to use for routing.

In certain embodiments, the transaction server 102 can determine which providers and payment rails are available for a transaction and further evaluates the available providers and payment rails for compatibility for handling the transaction. Computations and information about the transaction can be used to determine which payment routes are compatible. In the example shown in Table 1, the transaction server 102 determine that there is more than one provider that is compatible for a particular available payment rail.

Table 1 provides an example set of available providers and payment rails for a transaction:

TABLE 1

| Potential payment rail | Provider | Payment route |
|---|---|---|
| ACH | ProviderA | ACH-ProviderA |
| ACH Sameday | ProviderA | ACH-Sameday- |
| | | ProviderA |
| ACH | ProviderB | ACH-ProviderB |
| ACH Sameday | ProviderB | ACH-Sameday- |
| | | ProviderB |
| FedNow | ProviderC | FedNow-ProviderC |
| RTP | ProviderC | RTP-ProviderC |

The transaction server 102 can further narrow down the compatible payment routes to determine optimized payment routes by analyzing transaction historical data 164.

Payment routes can have differing terms for what use cases are allowed. For instance, the transaction server 102 may charge a fee for a payment transaction that uses the ACH rails, but not the RTP rails.

Using transaction information and computations, transaction server 102 can eliminate payment routes that are not eligible or compatible for handling a particular transaction.

Additionally, transaction server 102 can implement provisions at an early stage (e.g., before creating bids) to prevent the client from sending traffic in ways that are not suitable. For instance, transaction server 102 can implement measures to prevent a client from sending a vending machine purchase transaction via RTP, including excluding payment routes that use RTP from bids for the vending machine purchase transaction.

There can be situations when a reason for a rejection may be not obvious to transaction server 102, or even knowable. For instance, there might be one bank that rejects one particular use case that is allowed by the payment route to which they belong. This might be due to a technical limitation or error in implementation, or it might be deliberate.

The transaction server 102 can apply routing model 150, which can use machine learning and the historical transaction data 164 to available and/or compatible payment routes, such as by detecting patterns associated with returns and failures. For example, the transaction server 102 can apply different machine learning methods, such as the “random forest” learning method. This allows the transaction server 102 to spot such patterns. In this way, the transaction server 102 uses the historical transaction data 164 to improve service to clients, avoid the retrying transactions that were returned or failed, thus causing a reduction in transmission volume over networks used by transaction server 102 and/or the payment route, reduce delays in completing a transaction, and/or reduce messaging delay issues.

For instance, if the transaction server 102 notices a pattern of rejection of transactions across different clients having transaction amounts ending in $0.99 routed to First Bank of W, routed over FedNow when paired with a particular provider, but succeeding with other methods, the transaction server 102 can use this information to predict that this type of transaction will fail when using this payment route in combination with First Bank of W and FedNow. Accordingly, the transaction server 102 can eliminate that payment route as being available or compatible for all similar transaction across all clients.

Similarly, as another example, if First Bank of W has been enrolled in the RTP network, but the transaction server 102 has detected a pattern that all transactions sent to First Bank of W via the RTP network fail across all providers, The transaction server 102 can remove all payment routes that use RTP from the available or compatible payment routes for transactions sent to First Bank of W.

In some embodiments, the transaction server 102 can create bids for each compatible payment route.

The transaction server 102 can restrict bidding payment routes to compatible payment routes to ensure the winning bid is suitable to the transaction.

In an example, among different types of transactions are time-and-date-bound transactions. When a time-and-date bound transaction is specified in transaction information received by or provided to the transaction server 102, the transaction server 102 can narrow the bidding payment routes to those that can meet the deadline given.

For instance, if on a Monday at 11 AM the transaction server 102 receives a transaction request with a “deliver by midnight tonight” deadline, the transaction server 102 can eliminate payment routes that cannot meet that specified deadline, as shown in Table 2:

TABLE 2

| Potential | | | Earliest | |
|---|---|---|---|---|
| payment rail | Provider | Payment route | delivery time | Status |
| ACH | ProviderA | ACH-Sameday- | Monday | Active |
| Sameday | | ProviderA | evening | |
| ACH | ProviderB | ACH-Sameday- | Monday | Active |
| Sameday | | ProviderB | evening | |
| ACH | ProviderB | ACH-ProviderB | Tuesday | Eliminated |
| | | | evening | |
| FedNow | ProviderC | FedNow-ProviderC | Immediately | Active |
| RTP | ProviderC | RTP-ProviderC | Immediately | Active |

From there, transaction server 102 can then provide a bid with the price for each remaining payment route (meaning payment routes that were not eliminated) as shown in Table 3:

TABLE 3

| Payment route | Earliest delivery time | Price |
|---|---|---|
| ACH-Sameday-ProviderA | Monday evening | $0.05 |
| ACH-Sameday-ProviderB | Monday evening | $0.15 |
| FedNow-ProviderC | Immediately | $0.25 |
| RTP-ProviderC | Immediately | $0.20 |

When winning bids are tied for best price, the transaction server 102 can then choose one of the bids based on which payment route would arrive earlier. Additionally or alternatively, transaction server 102 can select a bid based on other factors such as historical performance of payment routes as indicated by the transaction historical data 164.

In some embodiments, the transaction server 102 can add client contract considerations to the bidding process.

The transaction server 102, when functioning as the provider of services to many clients, has the ability to optimize client traffic to reduce or minimize its overall cost of providing services to clients and/or the cost to clients of using its services.

To optimize client traffic, transaction server 102 can attempt to ensure that each client makes maximum use of any transactions included in their respective contracts by using those included transactions first, distributing transactions between pools of included transactions wherever possible.

In an example optimization for a client that involves selecting between two providers, the client has signed a monthly contract with the transaction server 102 that includes: 5,000 transactions with ProviderA at no additional cost (also referred to as free), and then a cost of $0.50 for every transaction afterwards; and 1,000 transactions with ProviderB at no additional cost, and then a cost of $0.10 for every transaction afterward.

While the per-transaction cost of ProviderA is higher, the transaction server 102 still prefers to route traffic in order to satisfy both minimums, after which the transaction server 102 picks the cheapest per-transaction option.

When free transactions are available on more than one option, a winner is can be randomly selected, e.g., based on the proportion of free transactions that still remain. In this same example (in which there is a contract between the client and the transaction server 102 that includes: 5,000 transactions with ProviderA and 1,000 transactions with ProviderB), at the start of a month there is a ⅚th chance ProviderA is selected and ⅙th chance ProviderB is selected.

In some embodiments, the transaction server 102 can safeguard against potential waste of included transactions.

In some embodiments, the transaction server 102 can also consider a case in which a client prefers that transactions be satisfied by a slower, cheaper option, but prefers a faster and usually more-expensive option when included transactions are available.

To illustrate, if a transaction suitable for a slow rail at $0.01 uses a free fast transaction, that means a later fast transaction must pay the normal fast rate of $0.50. The client saved only $0.01 on the first transaction, when the client could have saved $0.50 on the later transaction that demanded the fast payment route. The result is a waste of $0.49.

On the opposite side, if a free fast transaction remains unused at the end of the month while the client paid $0.01 for one or more slow transactions, the result is a waste of $0.01 per slow transaction. Such waste, even if relatively small per transaction, adds up to significant waste over multiple transactions for a single client, and likely an even larger amount of waste over all clients using the transaction server 102. Reduction of overall waste by the transaction server 102 can result in more efficient use of client resources or other efficiencies.

In some embodiments, the transaction server 102 can implement a method that incorporates the potential value saved into the bids. To do this, the transaction server 102 can run the projected and/or predicted remaining volume against the client's current contracts with their costs and included spend to determine a value for those transactions. This can be referred to as Projected Customer Transaction Value (PCTV).

This can be calculated as shown in Equation 3.

PCTV=Total Projected Spend for the Month for that Transaction Type/Number of Projected Transactions for that Transaction Type Equation 3:

To illustrate, a client enters into a contract with the transaction server 102 that includes: 5,000 slow transactions with ProviderA, and then a cost of $0.20 for every transaction afterward; 1,000 slow transactions with ProviderB, and then a cost of $0.10 for every transaction afterward; 1,000 fast transactions with ProviderC, and then a cost of $1.00 for every transaction afterward.

Based on the previous month's usage, the projections and/or predictions for the month are 10,000 slow transactions and 2,000 fast transactions. Other patterns and factors, that could be applied include, for example and without limitation, season, time of day, time of month, time of week, geographic location, world or local events, and/or weather.

The transaction server 102 in solving for the lowest cost scenario uses all 5,000 included slow transactions with ProviderA, then uses all 1,000 included slow transactions with ProviderB, then uses 4,000 slow transactions with ProviderB at $0.10 each; then uses 1,000 included fast transactions with ProviderC, and the uses the remaining 1,000 included fast transactions with Provider and then pays $1 per the remaining 1,000 transactions.

Slow transaction PCTV can then be calculated as $400 projected spend/10,000 total transactions projected and/or predicted to be sent=$0.004 per transaction. Fast transaction PCTV can then be calculated as $1,000 projected spend/2,000 total transactions expected to be sent=$0.50 per transaction. PCTV is then used by the transaction server 102 as a floor in bidding for price. Start-of-month PCTV (SPCTV) is stored by the transaction server 102 in the data storage devices 104 and becomes the basis for cost comparisons later.

At the start of the month, when a slow transaction shows up, there can be three “free” options, for example as shown in Table 4:

TABLE 4

| | Cost of next | | |
|---|---|---|---|
| | transaction | PCTV | Bid as |
| Slow, ProviderA | Free | $0.04 | $0.04 |
| Slow, ProviderB | Free | $0.04 | $0.04 |
| Fast, ProviderC | Free | $0.50 | $0.50 |

The transaction server 102 can then use an included transaction by making a randomized pick between options that are bid at the same price (which in this example are the first two options).

In some embodiments, the transaction server 102 can allocate transactions based on additional considerations, such as time of the month.

Through the month, PCTV will increase as monthly included free transactions are spent. When PCTV is less than SPCTV (calculated at the start of the month), it indicates underutilization, generally of a premium resource.

When PCTV is less than SCPTV, transaction server 102 can allow the allocation of some included premium (e.g., fast) transactions to be used for regular paid transactions, as shown in Equation 41

Projected Included Fast Transactions Used in Optimized Current Projection/Days of Month Remaining Equation 4:

Without include a throttling mechanism (or constant re-pricing), at the start of the day, the transaction server 102 can set the premium transactions to be priced at $0, which would cause the premium transactions to win the bids that day, expending the included premium count, with future fast transactions priced per-transaction.

Clients may decide to disable this behavior (e.g. by providing a corresponding command to the transaction server 102) to ensure that premium transactions are not spent in this way, at the risk of those included premium transactions going unused. A client could enable or disable this behavior at any time through an administrative interface, for example.

The transaction server 102 could provide, e.g., via the administrative interface and in regular reporting emailed to clients, visualizations of, for example: predicted transactions, identification of payment routes that are predicted to be used for the predicted transactions based on current trends, total price to the client at the end of the current billing period without enabling an optimization feature, and a difference in payment routes and associated cost if an optimization feature is enabled, e.g., as compared to without enabling the optimization feature. The transaction server 102 may only provide an option to implement the optimization feature on the condition that it offers a significant difference in cost, e.g., the difference being above a selectable threshold, such as $50.

In an example of a client having an option to activate an optimization feature, Client Foo has 1,000 included RTP transactions available. RTP, being particularly beneficial for time-sensitive use cases, may not be required by Client Foo when its current use cases are not time-sensitive. Client Foo also knows that towards the end of the month, it will be adding a new feature that allows users to make instant payments for a small fee.

A naive model would predict based on past traffic that the included RTP transactions would not be used and would thus be wasted and so recommend the included RTP transactions be used for payments that are not time sensitive. Client Foo, by having the option to disable the optimization feature, can ensure that when they turn on their new feature, those transactions consume their 1,000 RTP reserve. Transaction server 102 can do this automatically by determining the savings in view of the historical transaction data as well as planned events for the future (e.g., due to a planned sale (e.g., a pop-up sale), a planned change is pricing, a planned contract change), comparing the savings to a selectable threshold, and deciding whether to operate based on the optimization feature based on a result of the comparison.

In certain scenarios, this can come into play at the end of the month. For example, with a week remaining in the month, Client NewCo has sent far fewer premium transactions than projected and/or predicted based on trends, predetermined rules, the transaction historical data 164 for last month, while otherwise business has proceeded as predicted. NewCo has exhausted the included slow transactions, but 800 included fast transactions remain. Based on updated projections and/or predictions, Client NewCo is predicted to send 2,000 slow transactions and 100 fast transactions.

In some embodiments, the transaction server 102 can solve for the lowest overall cost which can decide as follows:
a. Send 100 fast transactions using the remaining included fast transactions
b. Send 700 slow transactions fast using the remaining included fast transactions
c. Send 1,300 slow transactions via ProviderB (which has the lowest per-transaction cost)

Slow transaction PCTV can be calculated by transaction server 102 as $130 projected and/or predicted spend/2,000 total transactions sent=$0.065 per transaction. Fast transaction PCTV can be calculated by transaction server 102 at $0 projected spend/100 fast total transactions sent=$0.00 PCTV.

That $0.00 PCTV is less than the $0.50 SPCTV [where did this SPCTV value come from?] from the start of the month, and so the transaction server 102 allocates some included fast transactions to be eligible to be included in bidding for slow transactions. The allocation with seven days remaining in the month is one-seventh of the optimized scenario projected and/or predicted. For this example, 100 fast transactions are so allocated.

For the next 100 slow transactions, the bidding appears as:

| Payment route | Cost of next transaction |
|---|---|
| Slow, ProviderA | $0.20 |
| Slow, ProviderB | $0.10 |
| Fast, ProviderC | Free |

The fast rail has the winning bid. And then afterward, once the allocated pool is expended, the bidding scenario returns to, as shown in Table 5:

TABLE 5

| Payment route | Cost of next transaction |
|---|---|
| Slow, ProviderA | $0.20 |
| Slow, ProviderB | $0.10 |
| Fast, ProviderC | $0.50 |

While the example describes usage of free and paid transactions, the approach is also applicable for use with tiered pricing. For example, if Client NewCo is currently paying ProviderA $0.20 for a particular transaction type, and Client NewCo is close to reaching a higher-volume tier with lower pricing of $0.10 per that transaction type, the projected and/or predicted volume for the remainder of the month includes the lower-cost transactions. Therefore, the PCTV of Provider A's transactions is determined to be lower than $0.20.

In some embodiments, the transaction server 102 can incorporate contract considerations into the bidding process. The transaction server 102 as a provider can manage a set of server-level contractual obligations between the transaction server 102 and one or more payment routes (that are above client-level of contracts between the client and the payment routes). The server-level contractual obligations can be codified as rules (e.g., as smart contract code). Example server-level contractual obligations include paying providers for included transaction volumes and then paying on a per-transaction basis.

For each bid, then, the transaction server 102 can also calculate an optimization price, which incorporates the progress against projected and/or predicted volumes and server-level contracts. The optimized price is calculated for the purpose of routing traffic to optimize cost based on the server-level contract terms for particular time periods defined by the server-level contract.

The optimized price that is optimized for the server-level contract can be incorporated into client bids, such that the client receives a lower price than would have received without application of the server-level contract, and the transaction server 102 can pay the difference.

For example, the transaction server 102 buys 100,000 transactions from ProviderA and ProviderB, and then pays $0.10 per transaction. Current projections and/or predictions of monthly volume show transaction server 102 exceeding the included transactions by 100,000 on ProviderA while substantially below the included transactions on ProviderB. The transaction server 102 can offer clients who have a choice of providers bids that are based on the included number of transactions that are still available.

Also disclosed is an apparatus having a memory configured to store a plurality of programmable instructions and a processing device in communication with the memory, wherein the processing device, upon execution of the plurality of programmable instructions is configured to perform the methods shown in FIGS. 3A and 3B.

Also disclosed is a tangible computer readable medium storing instructions that are executable by a processor for performing the methods shown in FIGS. 3A and 3B.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart(s) and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

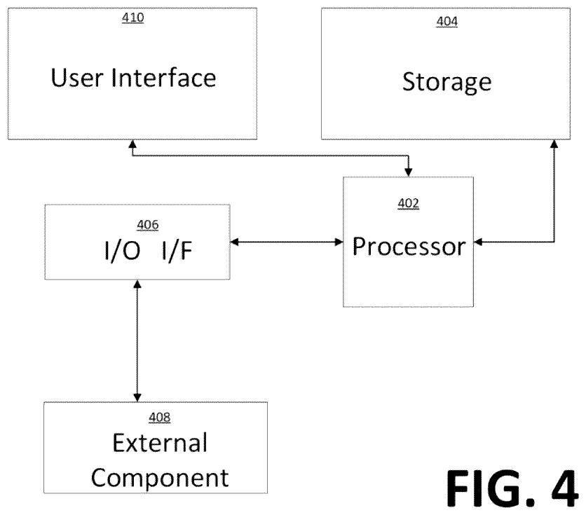

With reference to FIG. 4, a block diagram of an example processing system 400 is shown, which provides an example configuration of a computing system used by computing components of the digital payment system 100 shown in FIG. 1A. Additionally, all or portions of the computing components of the digital payment system could be configured as software, and processing system 400 could represent such portions. Processing system 400 is only one example of a suitable system and is not intended to suggest any limitation as to the scope of use or functionality of embodiments of the disclosure described herein. Processing system 400 can be implemented using hardware, software, and/or firmware. Regardless, processing system 400 is capable of being implemented and/or performing functionality as set forth in the disclosure.

Processing system 400 is shown in the form of a general-purpose computing device. Processing system 400 includes a processor 402, memory 404, an input/output (I/O) interface (I/F) 406 that can communicate with an internal component, such as a user interface 410, and optionally an external component 408.

Processor 402 includes one or more processing devices, such as a central processing unit and/or graphical processing unit. In certain embodiments, processor 402 can include, for example, microprocessor, DSP, a microcontroller, a field programmable gate array (FPGA), an application specific integrated circuit (ASIC) and/or other discrete or integrated logic circuitry having similar processing capabilities.

In certain embodiments, processor 402 and the memory 404 can be included in components provided in an FPGA, ASIC, microcontroller, or microprocessor, for example.

Memory 404 can include, for example, one or more memories, such as volatile and non-volatile memories for storing data temporarily or long term, and for storing programmable instructions executable by the processor 402. Memory 404 can be a removable (e.g., portable) memory for storage of program instructions. I/O I/F 406 can include an interface and/or conductors to couple to the one or more internal components 410 and/or external components 408.

Embodiments of the computing components of the digital payment system may be implemented or executed by one or more computer systems, such as a microprocessor. Each processing system 400 can be included within the computing components of the digital payment system, or multiple instances thereof.

In certain embodiments, processing system 400 is embedded in a device, such as user device 104. Portions of the processing system 400 can be provided externally, such by way of an interface.

Processing system 400 is only one example of a suitable system and is not intended to suggest any limitation as to the scope of use or functionality of embodiments of the disclosure described herein. Regardless, processing system 400 is capable of being implemented to perform any of the functionality set forth hereinabove.

Processing system 400 may be described in the general context of execution of computer system-executable instructions, such as program modules. Generally, program modules may include routines, programs, objects, components, logic, data structures, etc., that perform particular tasks or implement particular abstract data types.

With reference to FIG. 5, processing system 400 is shown in accordance with certain embodiments in which processor 402 includes one or more neural networks that can be convolutional or deconvolutional neural networks. Processing system 400 can be configured to store and implement AI processing unit(s) that can include one or more (accelerators, GPUs, TPUs); one or more ML models; and AI software, such as frameworks or libraries used for performance of AI tasks.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Potential technical advantages of the disclosed method include provision of access by a user via their digital wallet to a plurality of payment routes for a transaction that were not previously available to a digital wallet, namely the plurality of payment routes included in the enrolled payment route data 168 of collections 160. Using only one payment application, the user's device has access to this plurality of payment routes. This provides advantages of previous systems in which a user's digital wallet accessed one financial institution that was constrained to a particular payment route. A user would need to have many digital wallets in order to have access to the plurality of payment routes included in the enrolled payment route data. The user would need to select which digital wallet to use, and that decision would drive the selection of the payment route. However, the decision would not be optimized for the particular transaction. Each digital wallet consumes resources of the user's device, including memory space and screen space for displaying the icon.

Also, potential advantages include providing optimization transparent to the user and the user's digital wallet. A payment route that is optimized for the transaction is selected from the plurality of payment routes. The optimization can include avoiding traffic, failures, and/or returns and balance traffic and load to be used, optimizing for cost and/or speed. The optimization can use current conditions. For example, the optimization can be specific to the transaction's transaction information and can be specific to the time of the transaction. The optimization uses transaction history data related to the specific destination identified in the transaction information, which can be as specific as an institution, a routing number, and/or an account number identified with the transaction information's destination identifier.

Another potential advantage of the disclosed method and system is the ability to failover from one payment route to another, with the failover being transparent to the user and the user's payment application.

Another potential advantage of the disclosed method and system is the ability for different payment providers and payment rails to compete with one another, such as by offering sales, flash sales, competitive contracts, all of which can be dynamic and offered in real time. The user will reap savings in speed and/or cost. The auctioning and bidding can be transparent to the user and the user's payment application.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method comprising:
receiving API messages for a plurality of enrolled users, each API message having a transaction request from one of the users requesting a transfer of funds, the transaction request including transaction information that includes a value of the funds requested to be transferred, a source identifier, and a destination identifier;
processing one of the API messages by accessing the transaction information in the transaction request, comprising;
accessing a collection of a plurality of enrolled payment routes, each payment route including a different combinations of a plurality of payment rails and a plurality of payment providers for transferring funds, at least one of the payment rails of the plurality of payment rails being combined with different respective payment providers of the plurality of payment providers;
selecting a payment route from the plurality of payment routes to use for the requested transfer; and
submitting a routing request for routing the transaction request using the selected payment route and in accordance with the transaction information.

2. The method of claim 1, further comprising:
monitoring in real-time or near real-time the routing of the transaction via the selected payment route for a failure;
deciding whether to intervene in the routing of the transaction due to the failure;
upon deciding to intervene, repeating the selecting the payment route for selecting a revised payment route from the plurality of payment routes included in the enrolled payment routes; and
submitting a failover routing request for routing the transaction using the revised payment route.

3. The method of claim 1, wherein the method further comprises:
identifying a plurality of payment routes in the collection that are compatible for transferring the funds per the user transaction request; and
creating bid callouts for only the respective compatible payment routes, wherein selecting the payment route includes evaluating the bid callouts.

4. The method of claim 3, wherein evaluating the bid callouts comprises:
accessing historical data from past transactions routed via the different enrolled payment routes; and
predicting cost and/or speed of routing the transaction, wherein the predicting uses historical data of the historical past transactions that is relevant to the destination identifier for the transaction and optimization routing rules,
wherein selecting the payment route is based on a result of the predicted cost and/or speed.

5. The method of claim 4, wherein the historical data for a particular payment route includes failure data about returns or failures that occurred when using the payment route for past transactions, speed of routing respective past transactions using the payment route, and cost incurred for using the payment route for routing the past transactions.

6. The method of claim 4, further comprising applying a machine learning model to analyze the historical data for predicting the cost and/or speed.

7. The method of claim 3, wherein the method further comprises:
receiving external bids associated with usage of respective payment routes of the plurality of payment routes;
wherein evaluating the bid callouts includes determining effects of the received external bids on routing the transaction for the respective compatible payment routes,
wherein selecting the payment route is based on the determined effects.

8. The method of claim 3, wherein submitting the routing request is performed by a routing selection system and the method further comprises:
accessing contract data representing contract terms of a contract between the payment route and the user and/or contract terms of a contract between the different enrolled payment routes and the routing selection system,
wherein evaluating the bid callouts is based on an evaluation of application of the contract terms to the plurality of payment routes and/or selecting the payment route is based on an evaluation of application of the contract terms to the compatible payment routes.

9. The method of claim 4, wherein the transaction request includes an optimization selection, the optimization selection specifying a characteristic to use for optimizing the routing of the transaction request, the characteristic being selectable from cost for routing the transaction and speed of routing the transaction,
wherein selecting the payment route is further optimized on the optimization selection.

10. The method of claim 1, further comprising generating the routing request based on the user transaction request and the selected payment route.

11. The method of claim 10, further comprising applying a machine learning model to determine additional data to insert in the routing request, wherein generating the routing request includes inserting the additional data.

12. The method of claim 1, wherein the transaction request requests a plurality of transactions.

13. The method of claim 1, wherein each of the users has access to a digital wallet executing on an associated user device, wherein the API messages are received from the digital wallets of the associated user devices of the respective users.

14. A system comprising:
at least one memory storing programmable instructions; and
at least one processor in communication with the at least one memory, wherein the at least one processor, upon execution of the programmable instructions, is caused to:
receive API messages for a plurality of enrolled users, each API message having a transaction request from one of the users requesting a transaction that includes a transfer of funds, the transaction request including transaction information that includes a value of the funds requested to be transferred, a source identifier, and a destination identifier;
process one of the API messages by accessing the transaction information in the transaction request, the processing the API comprising:
accessing a collection of a plurality of enrolled payment routes, each payment route including a different combination of a payment rail of a plurality of payment rails and a payment provider of a plurality of payment providers for transferring funds, at least one of the payment rails of the plurality of payment rails being combined with different respective payment providers of the plurality of payment providers;
selecting a payment route from the plurality of payment routes to use for the requested transfer; and
submitting a routing request for routing the transaction using the selected payment route and in accordance with the transaction information.

15. The system of claim 14, wherein the at least one processor is further caused to:
monitor in real-time or near real-time the routing of the transaction via the selected payment route for a failure;
decide whether to intervene in the routing of the transaction due to the failure;
upon deciding to intervene, repeat the selecting the payment route for selecting a revised payment route from the plurality of payment routes included in the enrolled payment routes; and
submit a failover routing request for routing the transaction using the revised payment route.

16. The system of claim 14, wherein the at least one processor is further caused to:
identify a plurality of payment routes in the collection that are compatible for transferring the funds per the user transaction request; and
create bid callouts for only the respective compatible payment routes, wherein selecting the payment route includes evaluating the bid callouts.

17. The system of claim 16, wherein evaluating the bid callouts comprises:
accessing historical data from past transactions routed via the different enrolled payment routes; and
predicting cost and/or speed of routing the transaction, wherein the predicting uses historical data of the historical past transactions that is relevant to the destination identifier for the transaction and optimization routing rules,
wherein selecting the payment route is based on a result of the predicted cost and/or speed.

18. The system of claim 17, wherein the historical data for a particular payment route includes failure data about returns or failures that occurred when using the payment route for past transactions, speed of routing respective past transactions using the payment route, and cost incurred for using the payment route for routing the past.

19. The system of claim 17, wherein the at least one processor is further caused to apply a machine learning model to analyze the historical data for predicting the cost and/or speed.

20. The system of claim 16, wherein the at least one processor is further caused to:
receive external bids associated with usage of respective payment routes of the plurality of payment routes;
wherein evaluating the bid callouts includes determining effects of the received external bids on routing the transaction for the respective compatible payment routes,
wherein selecting the payment route is based on the determined effects.

21. The system of claim 16, wherein submitting the routing request is performed by a routing selection system and the at least one processor is further caused to:
access contract data representing contract terms of a contract between the payment route and the user and/or contract terms of a contract between the different enrolled payment routes and the routing selection system,
wherein evaluating the bid callouts is based on an evaluation of application of the contract terms to the plurality of payment routes and/or selecting the payment route is based on an evaluation of application of the contract terms to the compatible payment routes.

22. The system of claim 17, wherein the transaction request includes an optimization selection, the optimization selection specifying a characteristic to use for optimizing the routing of the transaction request, the characteristic being selectable from cost for routing the transaction and speed of routing the transaction,
wherein selecting the payment route is further optimized on the optimization selection.

23. The system of claim 14, wherein the at least one processor is further caused to generate the routing request based on the user transaction request and the selected payment route.

24. The system of claim 23, wherein the at least one processor is further caused to apply a machine learning model to determine additional data to insert in the routing request, wherein generating the routing request includes inserting the additional data.

25. The system of claim 14, wherein the transaction request requests a plurality of transactions.

26. The system of claim 14, wherein each of the users has access to a digital wallet executing on an associated user device, wherein the API messages are received from the digital wallets of the associated user devices of the respective users.

27. A non-transitory computer readable storage medium and one or more computer programs stored therein, the computer programs comprising instructions, which when executed by a computer system, cause the computer system to:
receive API messages for a plurality of enrolled users, each API message having a transaction request from one of the users requesting a transaction that includes a transfer of funds, the transaction request including transaction information that includes a value of the funds requested to be transferred, a source identifier, and a destination identifier;
process one of the API messages by accessing the transaction information in the transaction request, the processing the API comprising:
accessing a collection of a plurality of enrolled payment routes, each payment route including a different combination of a payment rail of a plurality of payment rails and a payment provider of a plurality of payment providers for transferring funds, at least one of the payment rails of the plurality of payment rails being combined with different respective payment providers of the plurality of payment providers;
selecting a payment route from the plurality of payment routes to use for the requested transfer; and
submitting a routing request for routing the transaction using the selected payment route and in accordance with the transaction information.
